(19) United States
(12) Patent Application Publication
(10) Pub. No.: US 2013/0027307 A1
(43) Pub. Date: Jan. 31, 2013

(54) HUMAN-MACHINE INTERFACE APPARATUS AND OPERATING METHOD THEREOF

(71) Applicants: Tianqiao Chen, Shanghai (CN); Zhenghua Yan, Shanghai (CN); Liqun An, Shanghai (CN)

(72) Inventors: Tianqiao Chen, Shanghai (CN); Zhenghua Yan, Shanghai (CN); Liqun An, Shanghai (CN)

(73) Assignee: SHANDA COMPUTER (SHANGHAI) CO., LTD, Shanghai (CN)

(21) Appl. No.: 13/261,186

(22) PCT Filed: Aug. 20, 2009
(86) PCT No.: PCT/CN2009/000956

§ 371 Date: Aug. 1, 2012

(51) Int. Cl. G06F 3/033

(52) U.S. Cl. 345/163

(57) ABSTRACT

In a human machine interface (HMI) apparatus, powered by a power supply, an assembly unit binds the apparatus to the user's hand. A laser determines the location of a cursor on a display interface of a host machine. A mode switch is used to switch among a touch mode, an air mouse mode, and a monitor remote control mode. A sensor captures motion signals from a user and a transmitter sends signals generated by the apparatus to a receiver in communication with the host machine. A control module transfers a user's motion signals to the transmitter. A button acts as a left mouse button when in touch mode and a key can act as a left or right mouse button. Remote control keys are also provided. The assembly unit can take the form of a glove, a portion which acts as a linear acceleration sensor and air angular velocity sensor.

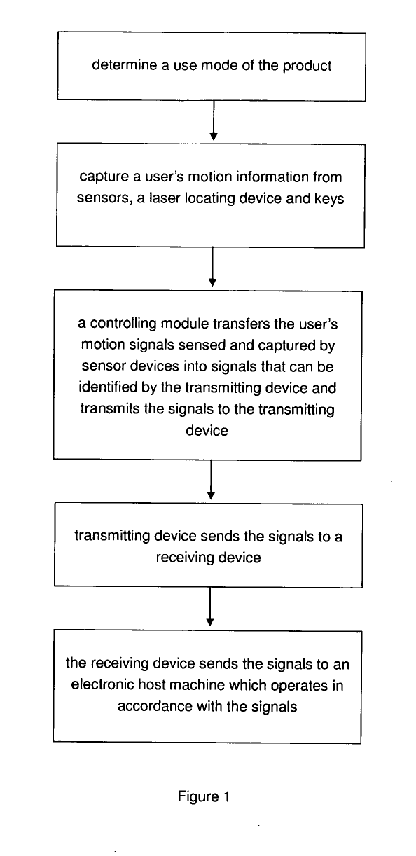

### FIELD OF THE INVENTION

The present invention relates to the field of human-machine interaction, particularly relates to the interactive entertainment based on computers, such as an interface apparatus for interaction between human beings and computers, video game consoles or similar devices used in the fields of games or education. The invention also relates to a manipulation method of the human-machine interface (HMI) apparatus.

### BACKGROUND OF THE INVENTION

A remote computer interface apparatus that can be operated manually and used with a keyboard is known in the computer field. It is well known that a computer mouse is usually considered as a computer interface apparatus, which is controlled by hand to move on a flat working surface and thus move the cursor on a computer monitor. Usually, the mouse often includes an electric switch which can be activated when the cursor is located at the required position to introduce inputs into the computer.

The problem of the mouse-like devices lies in that the mouse must be used on a fixed flat surface. A user must be close to the flat surface while using the mouse, which heavily limits its use places. Furthermore, the user must use a tool that is fixed on a flat surface such as a keyboard or writing board to perform actions like text inputs, which is an inefficient and tiring way for the user.

Improvements have been made to overcome the above defects by prior arts, however, it is unable to produce an human-machine interaction apparatus at low costs that can precisely sense actions from a user, can be nimbly controlled and will not be restricted by space and surface during operation.

### SUMMARY OF THE INVENTION

The technical problem to be solved in the invention is to provide an human-machine interaction (HMI) apparatus which can well determine a three-dimensional virtual location, be easily and operated by users and have low process cost.

To solve the above technical problem, a technical solution of an HMI apparatus is provided in the invention, comprising: a power supply used to provide power for the HMI apparatus; an assembly unit used to bind the HMI apparatus to a hand of a user; a laser locating device used to precisely determine where the cursor is located on the display interface of an electronic machine; a mode switching button used to switch among three operation modes of the HMI apparatus: touch mode, air mouse mode and action remote control mode; a sensor device used to sense and capture action signals of the user; a transmitting device used to send signals generated by the HMI apparatus to a receiving device connected with the electronic host machine; a controlling module used to transfer the user action signals sensed and captured by the sensor device to signals that can be identified by the transmitting device and transmit the signals to the transmitting device; a touch button which is used as the left mouse button when the HMI apparatus is under the touch mode; a key which is used as the left or right mouse button; and remote control keys used to achieve all existing functions of the remote control.

The assembly unit is a hollow out glove, comprising a back part of the glove and a finger sheath part wherein the back part of the glove is connected to the finger sheath part by a wire.

The wire between the finger sheath part and the back part of the hollow out glove is an electric wire that can be adjusted in length such that the assembly unit of the glove can suits hands of different sizes and be adapted for various users.

The finger sheath part comprises a forefinger sheath or further comprises a middle finger sheath. The length of the wire between the finger sheath and the back of hand is such that the finger sheath can be attached to other devices when it is removed from the user finger.

The touch button used as the left mouse button under the touch mode is located at the end of the forefinger sheath.

The key is provided at one side of the forefinger sheath facing the thumb. It is used as a left mouse button when the HMI apparatus is under the air mouse mode. A key is also provided on the middle finger sheath, which is used as a right mouse button when the HMI apparatus is under the air mouse mode.

The glove is a right-hand glove or a left-hand glove.

The back zone of hand of the assembly unit also includes a liner acceleration sensor with three axes, X, Y and Z, and an angular velocity sensor with two axes, Y and Z. The two sensors are used to obtain the space action of the user and as an air mouse and a motion sensing controller.

The power supply is a battery which is located at the wrist of the hollow out glove. The size of the wrist part of the hollow out glove is adjustable.

The assembly unit further comprises: a circular sensor that is equipped at the wrist of the other hand, which is a liner acceleration sensor with three axes, X, Y and Z, used to capture the space motion of the user; and a finger sheath of the other hand used to realize the functions of the motion sensing controller when the HMI apparatus is under the action remote control mode.

The circular sensor and the back part are connected with each other by plug wire and can be detached from each other. It further comprises a portion used to adjust the length of the plug wire such that the assembly unit of the glove can suits hands of different sizes and adapt to various users.

A transmitting device connected with an assembly unit provided on the other hand of the user, used to send signals generated by the portion to a receiving device connected with an electronic host machine.

The plug wire is an electric wire.

The finger sheath includes a forefinger sheath and a middle finger sheath.

The perimeter of the circular sensor can be adjusted so as to be adapted for different users.

A rocker and a key are arranged on the forefinger sheath. A controller for direction control is provided on the rocker to directly control the moving directions. The key is located at the end of the forefinger sheath and able to contact any contacting surface. A key is arranged on the end of the middle finger sheath or a side of middle finger sheath which faces the thumb.

The transmitting device and the receiving device comprise a code module and the receiving device has keys with wireless communication verifying codes.

A wheel key is further provided on the wrist part of the assembly unit, for the mouse to function as a wheel.

When the HMI apparatus is under the state of the touch mode, the non-touch-style movement of the touch button above the close touch surface will cause corresponding movement of the cursor on the display interface of the electronic machine, but will not leave motion traces on the display interface. The touch-style movement of the touch button on the touch surface will cause corresponding motion traces of the cursor on the display interface, which is equal to the movement state when the left mouse button is always pressed. When the key on the middle sheath contacts the touch surface, it indicates that the right mouse button is pressed.

When the HMI apparatus is under the air mouse mode, the user moves the cursor in the air by moving or turning his/her wrist. Meanwhile the key at the side of the forefinger sheath is used as the left mouse button and the key on the middle sheath is used as the right mouse button.

When the HMI apparatus is under the motion remote control mode, the user generates motion information by moving or turning his/her wrist. The controlling module transfers the user's motion signals sensed and captured by the sensor device into signals that can be identified by the transmitting device and transmits the signals to the transmitting device to realize the function of motion sensing control.

When the HMI apparatus is under the motion remote control mode, the motions of two hands can be sensed and detected with the sensors on the two hands of the user to realize the function of sensing and controlling the motions of two hands.

The present invention also provides a manipulation method of the HMI apparatus, comprising the following steps: Step 1: determine a use mode of the product; Step 2: capture the user's motion information from the sensors, the laser locating device and the keys; Step 3: the controlling module transfers the user's motion signals sensed and captured by the sensor device into signals that can be identified by the transmitting device and transmits the signals to the transmitting device; Step 4: the transmitting device sends the signals to the receiving device; Step 5: The receiving device sends the signals to the electronic host machine which operates in accordance with the signals.

An assembly unit that can be carried on the user's hand is used for the HMI apparatus in the present invention such that the apparatus is easy to carry and use by users. The laser locating device realized precise position. Moreover, multiple sensors are employed in the invention to sense various motions of the user such that different manipulation requirements on the electronic host machine can be satisfied through the HMI apparatus in the invention. The manipulation method of the HMI apparatus in the invention realized precise positioning of the HMI apparatus in the air and any surface and realized the function of capturing the user's motion in the air.

### BRIEF DESCRIPTION OF THE DRAWINGS

For more detailed description of the present invention, reference is now made to the accompanying drawings taken in conjunction with the embodiments.

The sole FIGURE illustrates a schematic drawing of the procedure of the manipulation method of the HMI apparatus in the invention.

### DETAILED DESCRIPTION

The HMI apparatus in the invention comprises a power supply, which is a battery. The battery is located at the wrist part of a hollow-out glove.

The HMI apparatus in the invention further comprises an assembly unit used to bind the HMI apparatus to one hand of a user. The assembly unit is a hollow-out glove, comprising a back part, a finger sheath part and areas for other keys. Other keys functioned as remote control keys are located at the back part of the hollow-out glove and other parts of the finger sheath, for example, the wrist part. The wrist part of the hollow-out glove comprises other components required by a remote controller, such as a battery cassette to accommodate a power supply. The back part completely contacts the user's opisthenar through the connecting part of the palm. The connection fully satisfies the ergonomics requirements so that the user feels comfortable and free. The connecting part further comprises a finger sheath connected with the back part with a wire. The wire between the finger sheath part and the back part can be adjusted in length, such that the assembly unit of the glove can suits hands of different sizes and be adapted for various users.

The finger sheath part comprises a forefinger sheath, which can be removed from the finger and can be used together with other peripheral equipments. For example, it can be attached to a penholder to be used as a pen by the user.

The finger sheath part comprises a laser locating device used to precisely determine the location of cursor on the display interface. The laser locating device is provided on the forefinger part of the assembly unit. When the HMI apparatus is under the touch mode, the function of laser locating is activated and the touch button of the forefinger tap acts as a left mouse button. Switching between pen down and pen up states is enabled by the contacting or detaching between the touch button and the reflective surface. The reflective surface can be any reflective surface, including multiple surfaces of reflective material such as clothes, hands, table surfaces (except for transparent glass), book or handrail of sofa. The touch button will be activated when it contacts a reflective surface and stock traces will be left on any reflective surface. The status under this mode is equivalent to the status when the left mouse button is pressed under conventional status. The user can move his/her hand in the way as writing and function as dragging the mouse, for example, accurate motion position and control on the surfaces for writing or drawing, by transmitting data of the horizontal coordinate (mouse position) to the electronic host machine through transmission of Radio Frequency signals. When the pen leaves the surface (but not too far from the surface), the laser is reflected and the cursor may be moved, but no pen traces is left, which enables the non-traces motion of the cursor. The user feels like using a touch pen for art designing. The user can take off the forefinger sheath and attach it to a penholder to use as a touch pen. As the laser is sharp enough to perform accurate positioning on any surface, the laser locating device can make the user's motion to be precisely located.

The finger sheath part also comprises a middle finger sheath. When the key on the middle finger sheath contacts the surface, it is equivalent to the status that the left mouse button is pressed. The assembly unit may further comprise sheaths for other fingers and have keys for other functions on it in accordance with requirements of the users.

The key is provided at one side of the forefinger sheath facing the thumb. It is used as a left mouse button when the HMI apparatus is under the air mouse mode. A key is also provided on the middle finger sheath, which is used as a right mouse button when the HMI apparatus is under the air mouse mode.

A wheel key is also set on the wrist part of the assembly unit to realize the function of a wheel mouse. Then the user can turn pages quickly and browse information in a convenient way.

Besides the above devices, the sensor devices of the present invention further comprises a liner acceleration sensor with three axes, X, Y and Z and an angular velocity sensor with two axes, Y and Z provided on the back zone of the assembly unit of the glove, which are used to obtain the space motion of the user and used as air mouse. These two sensors, the laser locating device, the touch button and the keys can be set on the left or right hand of the user.

When the HMI apparatus is under the air mouse mode, it functions as a 3D air mouse and the user can move the cursor in the air by moving or turning his/her wrist, using the key on the forefinger as the left mouse button and the key on the middle finger as the right mouse button. For example, when playing chess or card games, the user can select a card by moving his/her hand, i.e. select a card to be picked out by touching the left mouse button with the thumb, and release the thumb to pick out the card, which enables the most real effects of chess or card operation.

A circular sensor and a transmitter used to send signals generated by the HMI apparatus to a receiving device on an electronic host machine can be arranged at the wrist of the other hand of the user. The circular sensor is a liner acceleration sensor with three axes, X, Y and Z, used to obtain the space motion of the user. The assembly unit further comprises a forefinger sheath of the other hand and an additional middle finger sheath if the game requires. A rocker and a key are arranged on the forefinger sheath. A controller for direction control is provided on the rocker to directly control the moving directions. The key is located at the end of the forefinger sheath and able to contact any reflecting surface. A key is arranged on the end or side of the middle finger sheath. Furthermore, the circular sensor is connected with the forefinger sheath by a plug wire which includes a portion used to adjust the length of the plug wire. The circular sensor can be detached from the forefinger sheath. The circular sensor is connected with the middle finger sheath by a plug wire which includes a portion used to adjust the length of the cord. The circular sensor can be detached from the middle finger sheath.

When the HMI apparatus is under the motion remote control mode, the user generates motion information by moving or turning his/her wrist. The controlling module transfers the user's motion signals sensed and captured by the sensor device into signals that can be identified by the transmitting device and transmits the signals to the transmitting device to realize the function of motion reaction control. The actions of two hands can be sensed and detected with the sensors on the two hands of the user to achieve the function of sensing and responding to the motions of two hands. At this moment, the HMI apparatus in the invention functions as a motion sensing handle. Under this state, the user can play some games requiring big movements, such as playing tennis or ping-pong, boxing, or dancing as well as motions such like stirring, slicing and stir-frying during cooking.

The HMI apparatus in the invention may not be limited to the above structures and can further comprise various extended structures. For example, keys can be not only provided on the forefinger and middle finger of the assembly unit but also provided on other fingers. Further, the sheath on the finger can be taken off and be put on a penholder with a suitable sized port for connection. The apparatus is then used as a penholder-style product. Also, the forefinger sheath can be put on the head of a gun and be used as a gun-style product. Also, it may be used in products of other styles, such as a steering wheel or control lever, racket, baseball bat, fish pole, golf sticks, doll, bicycle, slide plate or other wheel-shaped objects.

The manipulation method of the HMI apparatus in the invention comprises the following steps as shown in the drawing: Step 1: determine a use mode of the product; Step 2: capture the user's motion information from the sensors, the laser locating device and the keys; Step 3: the controlling module transfers the user's motion signals sensed and captured by the sensor device into signals that can be identified by the transmitting device and transmits the signals to the transmitting device; Step 4: the transmitting device sends the signals to the receiving device; Step 5: The receiving device sends the signals to the electronic host machine which operates in accordance with the signals.

The HMI apparatus in the invention are not only appropriate for interaction between human beings and computers, but also can be used under the touch or air mouse mode to replace the laptop mouse. Under an air mouse mode, the product functions as air mouse; under touch mode, users can precisely operating the laptop mouse on any reflecting surface.

The user also can use the human machine interface device of the present invention to play various games, for example, chess and card games: under the air mouse mode, when playing Mahjong, the user can move his/her finger on the mahjong tiles (the mouse cursor on the screen is also moving at the moment), stop on the tile to be picked out, “hold” the tile with his/her thumb and forefinger (it is shown on the screen that the tile is selected at the moment), release fingers after holding and the tile will be picked out. Similarly, while playing card, the user selects a card by moving his/her finger, “holds” the chosen card and picks it out after releasing his/her finger. Also, the user can move the chess in the same way while playing chess.

Games like Cooking Mama can be operated through the HMI apparatus of the invention. When selecting menu items, a mode instruction is sent to the controller. After the controller is switched to the touch mode, the user can move the cursor on the tea table with his/her finger and touch the menu icon to select the item. During cook procedure, a mode instruction is sent to the controller. After the controller is switched to the motion remote control mode, the user can directly complete slicing motion in the air with his/her hand for vegetable slice, complete stirring motion in the air for egg stirring, “hold” and pour the soy sauce bottle with his/her hand in the air for sauce addition, and so on, which makes the game feel quite true.

The user can use the touch mode to search music in computer by the HMI apparatus of the invention. The user can write the text, for example “Faint Aroma” on the left palm with his right finger tip, search out the song of “Faint Aroma” after pressing OK and the user may download the song then. The user also can draw pictures through computer: under the touch mode, the user attaches the right finger sheath to a pen holder, directly draws lines on the drawing paper and the corresponding line traces such green lines will appear on the screen. When the nib leaves the paper, the user can move the cursor, stop on the Color bar, select Red with the nib and the color of the pen will be changed into red. A red line will appear when the user redraws it on the paper. The user also can play games like shooting, dancing and boxing by using the HMI apparatus of the invention.

The HMI apparatus of the invention can achieve precise positioning on any surface and be used on multiple kinds of reflecting surfaces such as clothes, hands and table surfaces (except transparent glass). Meanwhile the capture of air motions can control and locate the mouse, meeting users' requirements on interaction games manipulation and text input and providing more exciting and real experience for users.

What is claimed is:

1-23. (canceled)

24. A human-machine interface (HMI) apparatus, comprising:
a power supply used to provide power for the HMI apparatus;
a assembly unit used to bind the HMI apparatus to one hand of a user;
a laser locating device used to precisely determine location of a cursor on a display interface of an electronic host machine;
a mode switching button used to switch among three operation modes of the HMI apparatus: touch mode, air mouse mode and motion remote control mode;
a sensor device used to sense and capture motion signals from the user;
a transmitting device used to send signals generated by the HMI apparatus to a receiving device connected with an electronic host machine;
a control module used to transfer the user's motion signals sensed and captured by the sensor device into signals that can be identified by the transmitting device and transmits the signals to the transmitting device;
a touch button which is used as a left mouse button when the HMI apparatus is under the touch mode;
a key which is used as a left or a right mouse button; and
remote control keys used to achieve functions of remote control;
wherein, the assembly unit is a hollow out glove, comprising a back part and a finger sheath part wherein the back part is connected to the finger sheath part by a wire;
wherein, the back zone of the assembly unit comprises a liner acceleration sensor with three axes, X, Y and Z, and an angular velocity sensor with two axes, Y and Z, which are used to obtain the space motion of the user and are used as an air mouse and an action reaction controller; and
wherein, the circular sensor is connected with the back part through a plug wire, and can be detached from the back part; the circular sensor further includes a portion used to adjust the length of the cord such that the assembly unit of the glove can suits hands of different sizes and be adapted to various users.

25. An HMI apparatus according to claim 24, wherein the wire between the finger sheath part and the back part of the hollow out glove is a wire that can be adjusted in length such that the assembly unit of the glove can suits hands of different sizes and be adapted for various users.

26. An HMI apparatus according to claim 24, wherein the finger sheath part comprises a forefinger sheath or a middle finger sheath, wherein the length of the wire between the finger sheath and the back part is such that the finger sheath can be attached to other devices when it is removed from the user's finger.

27. An HMI apparatus according to claim 26, wherein the touch button used as a left mouse button under the touch mode is located at the end of the forefinger sheath.

28. An HMI apparatus according to claim 26, wherein a key is provided at one side of the forefinger sheath facing a thumb, and is used as a left mouse button when the HMI apparatus is under the air mouse mode; and a key is provided on the middle finger sheath, which is used as a right mouse button when the HMI apparatus is under the air mouse mode.

29. An HMI apparatus according to claim 24, wherein the glove is a right-hand glove or a left-hand glove.

30. An HMI apparatus according to claim 24, wherein the power supply is a battery which is located at the wrist of the hollow out glove and the size of the wrist part of the hollow out glove is adjustable.

31. An HMI apparatus according to claim 24, wherein the assembly unit further comprises: a circular sensor equipped at the wrist of the other hand; the circular sensor is a liner acceleration sensor with three axes, X, Y and Z and is used to obtain the space motion of the user; and a finger sheath of the other hand used to achieve the functions of a motion sensing controller when the HMI apparatus is under the motion remote control mode.

32. An HMI apparatus according to claim 24, further comprising a transmitting device connected with a assembly unit provided on the other hand of the user, used to send signals generated by the portion to a receiving device connected with an host electronic machine.

33. An HMI apparatus according to claim 31, wherein the wire is an electronic wire.

34. An HMI apparatus according to claim 24, wherein the finger sheath includes a forefinger sheath and a middle finger sheath.

35. An HMI apparatus according to claim 24, wherein perimeters of the circular sensor can be adapted to different users.

36. An HMI apparatus according to claim 34, further comprising a rocker and a key arranged on the forefinger sheath, a controller for direction control is provided on the rocker to directly control the moving directions, the key is located at the end of the forefinger sheath and able to contact any contacting faces; and a key is arranged on the end of the middle finger sheath or on a side of the middle finger facing the thumb.

37. An HMI apparatus according to claim 24, wherein the transmitting device and the receiving device include a code module and keys are provided on the receiving device for wireless communication coding.

38. An HMI apparatus according to claim 24, further comprising a wheel key set on the wrist part of the assembly unit for realizing wheel functions of a mouse.

39. An HMI apparatus according to claim 28, wherein when the HMI apparatus is under a state of the touch mode, a non-touch-style movement of the touch button above a closer touch surface will bring corresponding movements of a cursor on the display interface of the electronic host machine, but will not leave motion traces on the display interface; a touch-style movement of the touch button on the touch surface will bring corresponding motion traces of the cursor on the display interface, which is equivalent to the states when a left mouse button is being pressed; the states when the key on the middle sheath contacts the touch surface is equivalent to the states when a right mouse button is being pressed.

40. An HMI apparatus according to claim 31, wherein when the HMI apparatus is under an air mouse mode, the user moves a cursor by moving or turning his/her wrist in the air, and meanwhile a key at a side of a forefinger sheath is used as a left mouse button and a key on a middle sheath is used as a right mouse button.

41. An HMI apparatus according to claim 24, wherein when the HMI apparatus is under a motion remote control mode, a user generates movement information by moving or turning his/her wrist, and a control module transfers the user action signals sensed and captured by a sensor device into signals that can be identified by a transmitting device and transmits the signals to the transmitting device to achieve the function of motion sensing control.

42. An HMI apparatus according to claim 36, wherein when the HMI apparatus is under a motion remote control mode, the motions of two hands can be sensed and detected through sensors on the two hands of a user to achieve functions of sensing and responding to the motion of two hands.

43. A manipulation method of a HMI apparatus according to claim 24, comprising the following steps:
determining a use mode of the product;
capturing a user's motion information from sensors, a laser locating device and keys;
transferring via a controlling module, the user's motion signals sensed and captured by sensor devices into signals that can be identified by the transmitting device and transmits the signals to the transmitting device;
transmitting device sends the signals to a receiving device; and
sending via the receiving device, signals to an electronic host machine which operates in accordance with the signals.
